(19) United States
(12) Patent Application Publication
(10) Pub. No.: US 2024/0113386 A1
(43) Pub. Date: Apr. 4, 2024

(54) SECONDARY BATTERY

(71) Applicant: DIC Corporation, Tokyo (JP)

(72) Inventor: Kenichi Fujisaki, Saitama (JP)

(73) Assignee: DIC Corporation, Tokyo (JP)

(21) Appl. No.: 18/539,542

(22) Filed: Dec. 14, 2023

Related U.S. Application Data
(63) Continuation of application No. PCT/JP2022/023222, filed on Jun. 9, 2022.

(30) Foreign Application Priority Data
Jun. 17, 2021 (JP) 2021-100880

(51) Int. Cl. H01M 50/383; H01M 10/653; H01M 50/213

(52) U.S. Cl. CPC H01M 50/383; H01M 10/653; H01M 50/213

(57) ABSTRACT

A secondary battery that can suppress performance deterioration due to temperature rise and has excellent incombustibility is provided. The secondary battery contains two or more cells each including a cell stack that includes a positive electrode having a positive electrode terminal, a negative electrode having a negative electrode terminal, a separator interposed between the positive electrode and the negative electrode, and an electrolyte held by the separator and contains a second heat storage sheet including an incombustible layer. The second heat storage sheet is disposed between the two or more cells.

### TECHNICAL FIELD

One or more embodiments of the present invention relate to a secondary battery.

### BACKGROUND

In secondary batteries, the performance tends to decrease at a temperature out of a certain temperature range (for example, 15° C. to 35° C.). For example, at a low temperature of 0° C. or less, the electromotive force may significantly decrease to cause troubles in starting or charging. Accordingly, it is desirable that a battery is provided with a heat insulation mechanism that can keep the battery warm in a certain period of time from stop to next start.

In contrast, if the temperature of a battery is increased by heat generation during fast charging or high output discharging, instability of electrolyte and shortening of the battery life are caused, which may lead to significant performance deterioration. If the temperature exceeds 80° C., a risk of breakage of the battery also occurs. Accordingly, a cooling mechanism is essential, which requires large-scale equipment and so on, resulting in leading to a larger battery size. Furthermore, it is predicted in the future that the calorific value is more increased with progress of ultrafast charging, and it is required to develop a method for suppressing temperature rise that does not rely only on electricity.

In order to correspond to these demands, for example, PTL 1 discloses a vehicle battery pack (secondary battery) having a configuration in which a heat storage sheet is sandwiched between cells.

However, since many of heat storage materials included in heat storage sheets are generally combustible, there have been concerns that the fire would spread easily in case a secondary battery is damaged and caught fire by abnormality or the like of the cells constituting the secondary battery.

### PATENT LITERATURE

PTL 1: Japanese Unexamined Patent Application Publication No. 2009-140786

One or more embodiments of the present invention provide a secondary battery that can suppress the temperature rise of cells, the temperature rise causing deterioration of the secondary battery performance, and is provided with incombustibility at a level that can prevent the spread of fire even in the unlikely situation.

### SUMMARY

One or more embodiments of the present invention addressed the above by a secondary battery that comprises two or more cells each including a cell stack including a positive electrode having a positive electrode terminal, a negative electrode having a negative electrode terminal, a separator interposed between the positive electrode and the negative electrode, and an electrolyte held by the separator and comprises a second heat storage sheet including an incombustible layer, wherein the second heat storage sheet is disposed between the two or more cells.

According to one or more embodiments of the present invention, performance deterioration caused by the temperature rise of the secondary battery can be suppressed, and even if the secondary battery is damaged and caught fire by abnormality or the like of the cells, the spread of fire of the secondary battery can be prevented.

### BRIEF DESCRIPTION OF THE DRAWINGS

FIG. 1 is a perspective view showing a first embodiment of the secondary battery of the present invention.

FIG. 2 is a partial cross-sectional view of a cell cut along the A-A line in FIG. 1.

FIG. 3 is a partial cross-sectional view showing another configuration of the cell.

FIG. 4 is a perspective view showing a partial cutaway of a second embodiment of the secondary battery of the present invention.

FIG. 5 is a graph showing the results of simulation experiments of temperature rise suppression.

### DETAILED DESCRIPTION

The secondary battery 100 of one or more embodiments of the present invention comprises two or more cells 1 each including a cell stack including a positive electrode having a positive electrode terminal, a negative electrode having a negative electrode terminal, a separator interposed between the positive electrode and the negative electrode, and an electrolyte held by the separator and comprises a second heat storage sheet 30 including an incombustible layer 99, wherein the second heat storage sheet 30 is disposed between the two or more cells 1. This second heat storage sheet 30 contains a second heat storage material. In such a configuration, the second heat storage material absorbs the heat generated during charging of the secondary battery 100 (cells 1), and the temperature rise or the like of the cells 1 can be prevented. Accordingly, deterioration, fire, and so on of the cells 1 can be prevented. In addition, in the above configuration, even in case abnormality such as fire has occurred, the fire can be suppressed from spreading.

In the secondary battery 100 of one or more embodiments of the present invention, the second heat storage sheet 30 may be disposed so as to isolate the adjacent cells 1 from each other. In such a configuration, the heat generated during charging of the secondary battery 100 (cells 1) is absorbed by the second heat storage material, and thereby the temperature rises or the like of the cells 1 can be prevented. Accordingly, deterioration, fire, and so on of the cells 1 can be prevented before they happen. In addition, in the above configuration, even in case abnormality such as fire occurs in one of the cells 1, the spread of fire can be more effectively suppressed. Accordingly, fire or the like of other cells 1 can be suppressed.

In one or more embodiments, each of the cells 1 may be coated with a second heat storage sheet 30 in the periphery thereof such that a positive electrode tab 29 and a negative electrode tab 39 are exposed. Consequently, the temperature rises or the like of the cells 1 during charging or the like of the secondary battery 100 (cells 1) can be further effectively suppressed. In addition, in the above configuration, even in case abnormality such as fire occurs, the spread of fire can be more effectively suppressed.

A specific value of the melting point of the second heat storage material may be greater than 15° C. and 70° C. or less, 20° C. or more and 60° C. or less, 30° C. or more and 50° C. or less, and or 35° C. or more and 45° C. or less. The use of the second heat storage material having a melting point in such a range can absorb better the heat generated during charging or the like of the secondary battery 100 (cells 1).

The second heat storage material is not particularly limited, but examples thereof include fatty acid ester and alkane (paraffin). These compounds may be used alone or in combination of two or more. As the second heat storage material, an inorganic heat storage material also can be used.

Examples of the fatty acid ester include methyl myristate, methyl palmitate, ethyl palmitate, methyl stearate, and ethyl stearate. In particular, fatty acid ester may be methyl palmitate, ethyl palmitate, methyl stearate, or ethyl stearate or methyl stearate.

Examples of the alkane include hexadecane, heptadecane, octadecane, nonadecane, icosane, henicosane, and docosane. In particular, the alkane may be heptadecane, octadecane, nonadecane, icosane, henicosane, or docosane, or nonadecane, icosane, henicosane, or docosane, or icosane, henicosane, or docosane.

The second heat storage material may be in a form of a coated particle coated with an outer shell made of an organic material such as a melamine resin, an acrylic resin, and a urethane resin. Consequently, it is possible to prevent exudation of the second heat storage material during melting by phase change.

In this case, the average particle diameter of the coated particle is not particularly limited, but may be 10 to 1000 μm or 50 to 500 μm.

It is preferable that a primary particle has an average particle diameter within the above range. However, a primary particle having an average particle diameter of 1 to 50 μm (preferably 2 to 10 μm) may aggregate to form a secondary particle, and this secondary particle may have an average particle diameter within the above range.

The average particle diameter of a coated particle can be the median diameter (particle size corresponding to 50% of volume cumulative distribution: 50% particle diameter) obtained by measurement with a laser diffraction particle size analyzer (manufactured by HORIBA, Ltd., “LA-950V2”).

The second heat storage sheet 30 holds the second heat storage material (coated particle) and may contain a resin for bonding between second heat storage material molecules. A second heat storage sheet 30 having voids is easily produced by the resin bonding between the first heat storage material molecules into a three-dimensional mesh shape.

The moisture content in the second heat storage material may be 3 mass % or less, 2 mass % or less, 1.5 mass % or less, or 1.2 mass % or less. Occurrence of minute swelling, dent, and so on in the obtained second heat storage sheet 30 is easily suppressed by adjusting the moisture content in the second heat storage material in the above range, and the second heat storage sheet 30 having a suitable appearance is easily obtained.

The second heat storage sheet 30 may contain a resin forming a matrix.

Examples of the resin include a thermoplastic resin, a thermosetting resin, and an ultraviolet-curing resin. In particular, the thermoplastic resin is excellent in the moldability of the second heat storage sheet 30 and is preferable as the resin.

Examples of the thermoplastic resin include a vinyl chloride resin, an acrylic resin, a urethane resin, an olefin resin, an ethylene-vinyl acetate copolymer, a styrene-butadiene resin, a polystyrene resin, a polybutadiene resin, a polyester resin, a polyamide resin, a polyimide resin, a polycarbonate resin, a 1,2-polybutadiene resin, a polycarbonate resin, and a polyimide resin. In particular, a vinyl chloride resin easily increases the moldability at a low temperature and the dispersibility of the second heat storage material and is therefore preferable.

The use of a vinyl chloride resin is preferable because the second heat storage sheet 30 can be produced at a low temperature by preparing a resin composition using the particle of the vinyl chloride resin and forming a sol cast film. The resin composition is a paste-form composition in which the second heat storage material is dispersed in a mixture of a vinyl chloride resin particle and a plasticizer.

The average particle diameter of the vinyl chloride resin particle may be 0.01 to 10 μm or 0.1 to 5 μm. In the resin composition, the vinyl chloride resin particle may be directly dispersed in a primary particle state or may be dispersed in an aggregated state of a primary particle as a spherical secondary particle.

Alternately, vinyl chloride resin particles having different average particle diameters may be mixed to have a particle size distribution having two or more peaks. The particle diameter can be measured by a laser method or the like.

The shape of the vinyl chloride resin particle may be an approximately spherical shape because it easily exhibits suitable fluidity and the change in viscosity on aging is small.

The vinyl chloride resin particle may be manufactured by emulsion polymerization or suspension polymerization because a spherical shape is likely to be formed and the particle size distribution can be easily controlled.

The degree of polymerization of the vinyl chloride resin may be 500 to 4000 or 600 to 2000. In the above range, the rotational viscometer viscosity and the steady shear viscosity of the resin composition can be easily adjusted in a suitable range.

As the vinyl chloride resin particle, commercially available products can be suitably used. Examples of the commercially available product include ZEST PQ83, PWLT, PQ92, and P24Z (all of them manufactured by SHINDAI-ICHI VINYL CORPORATION) and PSL-675 and 685 (all of them manufactured by KANEKA CORPORATION).

When a thermoplastic resin is used, the content of the thermoplastic resin in the second heat storage sheet 30 may be 10 to 80 mass %, 20 to 70 mass %, or 30 to 60 mass %. In such a range, a matrix of the resin can be suitably formed in the second heat storage sheet 30, and a second heat storage sheet 30 with flexibility and toughness is easily formed. In addition, in the above range, the storage modulus of the second heat storage sheet 30 is easily adjusted in a suitable range. The second heat storage sheet 30 excellent in flexibility is easily bent to coat the cells 1 easily, for example, when the circumferences of the cylindrical cells 1 are coated with the second heat storage sheet 30 as shown in FIG. 4.

When a thermoplastic resin is used, a plasticizer may be mixed with the resin composition because good coatability and moldability of the resin composition are easily secured.

Examples of the plasticizer include an epoxy plasticizer, a methacrylate plasticizer, a polyester plasticizer, a polyether ester plasticizer, an aliphatic diester plasticizer, a trimellitate plasticizer, an adipate plasticizer, a benzoate plasticizer, and a phthalate plasticizer. These plasticizers may be used alone or in combination of two or more.

As the plasticizer, a commercially available product can be appropriately used.

Examples of the commercially available epoxy plasticizer include MONOCIZER W-150 manufactured by DIC Corporation; SANSO CIZER series E-PS, E-PO, E-4030, E-6000, E-2000H, and E-9000H manufactured by New Japan Chemical Co., Ltd.; ADEKA CIZER series O-130P, O-180A, D-32, and D-55 manufactured by ADEKA Corporation; and KAPDX S-6 manufactured by Kao Corporation.

Examples of the commercially available polyester plasticizer include Polycizer series W-2050, W-2310, and W-230H manufactured by DIC Corporation; ADEKA CIZER series PN-7160, PN-160, PN-9302, PN-150, PN-170, PN-230, PN-7230, and PN-1010 manufactured by ADEKA Corporation; D620, D621, D623, D643, D645, and D620N manufactured by Mitsubishi Chemical Corporation; and HA-5 manufactured by Kao Corporation.

Examples of the commercially available trimellitate plasticizer include MONOCIZER W-705 manufactured by DIC Corporation; ADEKA CIZER C-9N manufactured by ADEKA Corporation; and TOTM and TOTM-NB manufactured by Mitsubishi Chemical Corporation.

Examples of the commercially available benzoate plasticizer include MONOCIZER PB-3A manufactured by DIC Corporation; and JP120 manufactured by Mitsubishi Chemical Corporation.

It is preferable to use, among the above plasticizers, a plasticizer that can gel particularly at a low temperature because exudation of the second heat storage material and the plasticizer is easily suppressed.

The gelling end temperature of the plasticizer may be 150° C. or less, 140° C. or less, 130° C. or less, 120° C. or less, or 110° C. or less. The gelling end temperature can be the temperature at which the light transmittance of the gel film becomes constant.

Examples of the plasticizer with good low-temperature moldability include an epoxy plasticizer, a polyester plasticizer, and a benzoate plasticizer. These plasticizers with good low-temperature moldability are preferable because they easily impart a suitable heat storage property and toughness to the matrix of a resin.

From the viewpoint of the heat-resisting property and the low-temperature moldability, the epoxy plasticizer and the polyester plasticizer can be used.

Specifically, the gelling end temperature can be the temperature at which the light transmittance becomes constant when a composition is prepared by mixing a vinyl chloride resin (polymerization degree: 1700) for paste, the above plasticizer, and a heat stabilizer (Ca—Zn base) at a mass ratio of 100/80/1.5, this composition is inserted between a glass plate and a prepared slide, then the temperature is increased at a temperature-increasing rate of 5° C./min, and the change in the light transmittance is observed using a hot stage (Metter 800) for microscopic observation.

The viscosity of the plasticizer at 25° C. may be 1500 mPa·s or less, 1000 mPa·s or less, 500 mPa·s or less, or 300 mPa·s or less.

Since the use of a plasticizer having a viscosity within such a range can keep the viscosity of the resin composition for producing the second heat storage sheet 30 low, the filling ratio of the second heat storage material in the second heat storage sheet 30 can be increased.

In this case, the rotational viscometer viscosity and the steady shear viscosity of the resin composition can be easily adjusted in a suitable range.

The weight average molecular weight of the plasticizer may be 200 to 3000 or 300 to 1000. In this case, the plasticizer itself hardly exudes and can keep the viscosity of the resin composition low. Consequently, the filling ratio of the second heat storage material in the second heat storage sheet 30 can be increased.

In this case, the rotational viscometer viscosity and the steady shear viscosity of the resin composition is easily adjusted in a suitable range.

The weight average molecular weight (Mw) is a polystyrene-converted value based on the measurement by gel permeation chromatography (hereinafter, abbreviated to “GPC”). The GPC measurement can be performed under the following conditions.

### <Conditions for Measurement of Weight Average Molecular Weight>

Measurement apparatus: guard column “HLC-8330” manufactured by Tosoh Corporation;
Columns: “TSK Super H-H” manufactured by Tosoh Corporation,
   “TSK gel Super HZM-M” manufactured by Tosoh Corporation,
   “TSK gel Super HZM-M” manufactured by Tosoh Corporation,
   “TSK gel Super HZ-2000” manufactured by Tosoh Corporation, and
   “TSK gel Super HZ-2000” manufactured by Tosoh Corporation;
Detector: RI (differential refractometer);
Data processing: “GPC-8020 model II version 4.10” manufactured by Tosoh Corporation;
Column temperature: 40° C.;
Developing solvent: tetrahydrofuran (THF);
Flow rate: 0.35 mL/min;
Sample: filtrate (100 μL) obtained by filtration of a tetrahydrofuran solution of 1.0 mass % in terms of resin solid content through a microfilter; and
Standard sample: the following monodisperse polystyrenes having known molecular weights are used with reference to the measurement manual of the “GPC-8020 model II version 4.10”.

### <Standard Sample: Monodisperse Polystyrene>

“A-300” manufactured by Tosoh Corporation;
“A-500” manufactured by Tosoh Corporation;
“A-1000” manufactured by Tosoh Corporation;
“A-2500” manufactured by Tosoh Corporation;
“A-5000” manufactured by Tosoh Corporation;
“F-1” manufactured by Tosoh Corporation;
“F-2” manufactured by Tosoh Corporation;
“F-4” manufactured by Tosoh Corporation;
“F-10” manufactured by Tosoh Corporation;
“F-20” manufactured by Tosoh Corporation;
“F-40” manufactured by Tosoh Corporation;
“F-80” manufactured by Tosoh Corporation;
“F-128” manufactured by Tosoh Corporation; and
“F-288” manufactured by Tosoh Corporation.

When the second heat storage material is a coated particle, it is preferable to use, among the above plasticizers, a plasticizer having an HSP distance of 6 or more from the second heat storage material. The use of such a plasticizer can suppress the occurrence of a desorption component from the second heat storage sheet 30 at a high temperature. In addition, the second heat storage sheet 30 easily achieves a suitable heat-resisting property that hardly causes volumetric shrinkage even at a high temperature.

Here, a heat storage sheet containing a heat storage material may cause significant volumetric shrinkage at a high temperature. It is possible to suppress the intake of the plasticizer in the second heat storage material, the intake generating a large amount of desorption component at a high temperature, by adjusting the HSP distance between the second heat storage material and the plasticizer within the above range. As a result, the volumetric shrinkage of the second heat storage sheet 30 at a high temperature is easily suppressed, and a suitable heat-resisting property is easily achieved.

This HSP distance may be 7 or more or 8 or more because a suitable heat-resisting property is easily obtained. The upper limit of the HSP distance is not particularly limited, but may be 40 or less, 30 or less, or 25 or less because suitable compatibility and moldability are easily obtained.

The HSP distance is an indicator representing the solubility between substances using a Hansen solubility parameter (HSP). The Hansen solubility parameter represents the solubility by a multi-dimensional (typically, three-dimensional) vector, and this vector can be represented by a dispersion term, a polar term, and a hydrogen bond term. The vector similarity is represented as the distance of the Hansen solubility parameter (HSP distance).

Numerical values of the Hansen solubility parameter are presented in various literatures as references, and examples thereof include Hansen Solubility Parameters: A User's Handbook (Charles Hansen, et al., 2007, 2nd edition). Alternatively, the Hansen solubility parameter also can be calculated using commercially available software, for example, Hansen Solubility Parameter in Practice (HSPiP) based on the chemical structure of a substance. The calculation is performed at a solvent temperature of 25° C.

Preferable examples of the combination of the plasticizer and the second heat storage material include the following combinations.

When a second heat storage material having an outer shell of an acrylic resin (coated particle) is used, an epoxy plasticizer, a polyester plasticizer, a trimellitate plasticizer, or the like can be used.

When a second heat storage material having an out shell of a melamine resin (coated particle) is used, for example, an epoxy plasticizer, a polyester plasticizer, a trimellitate plasticizer, a benzoate plasticizer, or the like can be used.

In particular, epoxy plasticizer is preferable because it can impart various characteristics, such as a heat-resisting property, to the second heat storage sheet 30.

In the second heat storage sheet 30, the HSP distance between the thermoplastic resin and the plasticizer to be used may be 15 or less or 12 or less because a matrix of a resin is likely to be suitably formed. The lower limit of the HSP distance is not particularly limited, but may be 1 or more, 2 or more, or 3 or more.

When a coated particle is used as the second heat storage material, the plasticizer that can be suitably used is a plasticizer of which the absorption amount when the plasticizer is mixed with a second heat storage material is 150 parts by mass or less with respect to 100 parts by mass of the second heat storage material measured in accordance with JIS K5101-13-1.

The use of such a plasticizer can suppress the occurrence of a desorption component from the second heat storage sheet 30 at a high temperature, and a suitable heat-resisting property that hardly causes volumetric shrinkage even at a high temperature can be achieved.

The absorption amount of the plasticizer may be 140 parts by mass or less, 135 parts by mass or less, or 130 parts by mass or less because a suitable heat-resisting property is easily obtained. The lower limit of the absorption amount is not particularly limited, but may be 5 parts by mass or more or 10 parts by mass or more because suitable compatibility and moldability are easily obtained. When the absorption amount of the plasticizer is within the above range, the storage modulus of the resin composition is easily adjusted in a suitable range.

The absorption amount of the plasticizer is measured in accordance with the measurement method of oil absorption in JIS K5101-13-1. Specifically, 1 to 20 g of a second heat storage material is weighed according to the expected absorption amount and is placed on a glass plate as a sample, and a plasticizer is gradually added thereto 4 to 5 drops at a time from a burette. At each time, the plasticizer is kneaded into the sample with a stainless steel palette knife. This procedure is repeated, and the dropping is continued until a lump of the plasticizer and the sample is formed. Then, a procedure of adding the plasticizer thereto one drop at a time and completely kneading them is repeated, and the time at which the paste becomes smooth and hard is defined as the end point. The absorption amount at this time is defined as the absorption amount of the plasticizer.

The end point is when the paste can spread without cracking or becoming crumbly and slightly adheres to a measurement plate.

As the second heat storage sheet 30, a sheet having an incombustible layer 99 on one or both of the surfaces of a coating film obtained by applying a resin composition containing a resin and a second heat storage material on a support and heating it can be used. It is preferable to use a sheet having an incombustible layer 99 on one surface of the coating film as the second heat storage sheet 30.

The coating film constituting the second heat storage sheet 30 can be produced by preparing a resin composition containing a resin and a second heat storage material, applying this resin composition on a support to form a coating film, and then heating the coating film at a temperature of 150° C. or less.

As the support, a film-like base material that can be released from the second heat storage sheet 30 and has a heat-resisting property at the temperature in the heating step can be suitably used.

As the film-like base material, for example, a resin film that is used as various process films can be suitably used. Examples of the resin film include polyester resin films such as a polyethylene terephthalate resin film and a polybutylene terephthalate resin film.

The thickness of the resin film is not particularly limited, but may be 25 to 100 μm from the viewpoint of ease in handling and acquisition.

The surface of the resin film may be subjected to release treatment. Examples of the release treatment agent that is used in the release treatment include an alkyd resin, a urethane resin, an olefin resin, and a silicone resin.

Cast film formation by applying a resin composition on a support can be performed by using a coater such as a roll knife coater, a reverse roll coater, and a comma coater. In particular, it is possible to preferably use a method by sending a resin composition on a support and forming a coating film with a certain thickness by a doctor knife or the like.

The formed coating film can be molded into a sheet by gelation or curing through heating or drying.

The temperature of the coating film during heating (heating temperature) may be 150° C. or less, 140° C. or less, 130° C. or less, or 120° C. or less. The destruction (decomposition and deterioration) due to the heat of the second heat storage material can be suitably suppressed by setting the temperature of the coating film in the above range.

The heating time may be appropriately adjusted according to the gelation kinetics and so on and may be about from 10 seconds to 10 minutes.

The coating film may be subjected to drying, such as air drying, as appropriate, simultaneous to the heating.

When the resin composition contains a solvent, the solvent may also be removed simultaneously in the heating step, but pre-drying before the heating is also preferable.

The second heat storage sheet 30 is released from the support and is used. This releasing may be performed by a suitable method as appropriate.

The resin composition (coating solution) for forming the second heat storage sheet 30 may be prepared by mixing appropriately according to the resin and the second heat storage material. For example, when a vinyl chloride resin is used as the resin, the coating film may be formed by sol casting using a vinyl sol coating solution containing a vinyl chloride resin particle. In this case, the coating film can be molded at a low temperature without using kneading, extrusion molding, or the like with a mixer or the like. Consequently, the second heat storage material is hardly destructed, and the second heat storage material hardly exudes from the obtained second heat storage sheet 30.

The vinyl sol coating solution can also contain a solvent as appropriate. As the solvent, the solvents that are used in sol casting of the vinyl chloride resin can be appropriately used. In particular, examples of the solvent include ketones such as diisobutyl ketone and methyl isobutyl ketone; esters such as butyl acetate; and glycol ethers. These solvents may be used alone or in combination of two or more.

The above solvents are preferable because they slightly swell the resin at an ordinary temperature to easily facilitate dispersion and easily promote the melting gelation in the heating step.

A diluent solvent may be used together with the above solvent. As the diluent solvent, a solvent that does not dissolve a resin and suppresses the swelling property of the dispersion solvent may be used. Examples of the diluent solvent include paraffin hydrocarbon, naphthene hydrocarbon, aromatic hydrocarbon, and terpene hydrocarbon.

The vinyl sol coating solution can be mixed with a heat stabilizer for suppressing decomposition deterioration and coloring due to mainly a dehydrochlorination reaction of the vinyl chloride resin. Examples of the heat stabilizer include a calcium zinc stabilizer, an octyl tin stabilizer, and a barium zinc stabilizer. The content of the heat stabilizer in the vinyl sol coating solution may be 0.5 to 10 parts by mass based on 100 parts by mass of the vinyl chloride resin.

The vinyl sol coating solution may include additives, such as a thinner, a dispersant, and an antifoaming agent, as components other than the above, as needed. The contents of these additives each may be 0.5 to 10 parts by mass based on 100 parts by mass of the vinyl chloride resin.

The viscosity of the vinyl sol coating solution at the time of coating may be appropriately adjusted depending on the thickness of the target second heat storage sheet 30 and the coating conditions, and the viscosity may be 1000 mPa·s or more, 3000 mPa·s or more, or 5000 mPa·s or more because a good coatability is easily obtained. The upper limit of this viscosity may be 70000 mPa·s or less, 50000 mPa·s or less, 30000 mPa·s or less, or 25000 mPa·s or less. The viscosity of the coating solution can be measured with a B-type viscometer.

In the second heat storage sheet 30 consisting of a sol cast film of a vinyl sol coating solution containing the vinyl chloride resin particle and the second heat storage material, since no shear or pressure is applied to the second heat storage material during manufacturing, the second heat storage material is hardly destructed. Accordingly, exudation of the second heat storage material hardly occurs even while using a resin-based material. In addition, a second heat storage sheet 30 having a heat storage property due to the second heat storage material and having a good flexibility is obtained. Furthermore, the second heat storage sheet 30 can be easily stacked with another layer and processed and is therefore suitably applied to a secondary battery 100.

The content of the second heat storage material in the second heat storage sheet 30 may be 10 to 90 mass %, 20 to 70 mass %, or 30 to 50 mass % because a suitable heat storage property is easily achieved.

The content of the plasticizer in the second heat storage sheet 30 may be 5 to 75 mass %, 10 to 70 mass %, 20 to 60 mass %, or 20 to 40 mass %. In this case, good coating suitability and moldability of the resin composition are easily obtained.

The quantity proportion of the plasticizer based on 100 parts by mass of the thermoplastic resin may be 30 to 150 parts by mass, 40 to 130 parts by mass, or 50 to 120 parts by mass because the viscosity of the resin composition can be easily adjusted in a suitable range.

The thickness of the second heat storage sheet 30 is not particularly limited, but may be 100 to 6000 μm, 300 to 4000 μm, or 500 to 3000 μm. In this case, the heat storage property of the second heat storage sheet 30 can be more improved while effectively preventing heat transfer between adjacent cells 1 from each other.

The second heat storage sheet 30 that is used in a secondary battery of one or more embodiments of the present invention includes an incombustible layer 99.

The incombustible layer 99 may constitute one or both of the surfaces of the second heat storage sheet 30.

As the incombustible layer 99, for example, incombustible paper, aluminum, iron, or an inorganic material can be used, and it is preferable to use aluminum or incombustible paper. The use of aluminum is more preferable for achieving both excellent incombustibility and thermal diffusion effect. As the incombustible layer 99, a paper form, such as incombustible pater, or a thin film or sheet form, such as aluminum foil, can be used.

The incombustible paper is not particularly limited as long as it has incombustibility. For example, paper applied, impregnated, or internally added with a flame retardant can be used. As the flame retardant, metal hydroxides such as magnesium hydroxide and aluminum hydroxide, basic compounds such as phosphate, borate, and stephamate, and glass fibers are exemplified.

The incombustible layer 99 may have a thickness within a range of 3 to 1000 μm or within a range of 3 to 300 μm for being incorporated compactly. For example, when the circumferences of the cylindrical cells 1 are coated with the second heat storage sheet 30 as shown in FIG. 4, the second heat storage sheet 30 can be easily curved, and an optimal number of the cells 1 can be installed in a case.

When the incombustible paper is used as the incombustible layer 99, the second heat storage sheet 30 can be obtained by pasting the incombustible paper to one or both of the surfaces of a sheet-like material obtained using the resin and the second heat storage material. The second heat storage sheet 30 can also be obtained by applying an incombustible coating material to one or both of the surfaces of the sheet-like material to form an incombustible layer.

The tensile strength of the second heat storage sheet 30 may be 0.1 MPa or more, 0.3 MPa or more, 0.6 MPa or more, or 1 MPa or more. In this case, the second heat storage sheet 30 provided with toughness while maintaining flexibility can be obtained. The second heat storage sheet 30 is preferred because cracks are unlikely to occur during processing or transportation, and suitable processability, ease in handling, suitability for transportation, and suitability for bending are easily expressed.

The upper limit of the tensile strength of the second heat storage sheet 30 is not particularly limited, but may be 15 MPa or less, 10 MPa or less, or 5 MPa or less.

The elongation percentage of the second heat storage sheet 30 at the time of tensile fracture may be 10% or more, 15% or more, 20% or more, or 25% or more. In this case, embrittlement of the second heat storage sheet 30 can be suppressed. In the second heat storage sheet 30, cracking or chipping is unlikely to occur even when bending or distortion occurs during processing or transportation.

The upper limit of the elongation percentage of the second heat storage sheet 30 at the time of tensile fracture may be 1000% or less, 500% or less, or 300% or less. In this case, the second heat storage sheet 30 can have suitable flexibility while being tough. Accordingly, the second heat storage sheet 30 more easily expresses good processability, ease in handling, suitability for transportation, and suitability for bending.

The tensile strength and elongation percentage at the time of tensile fracture of the second heat storage sheet 30 are measured respectively as in the tensile strength and elongation percentage at the time of tensile fracture of the first heat storage sheet 20.

In one or more embodiments, each of the cells 1 is coated with a second heat storage sheet 30 in the periphery thereof such that a positive electrode tab 29 and a negative electrode tab 39 are exposed, but the cells 1 may be arranged so as to sandwich the second heat storage sheet 30 therebetween.

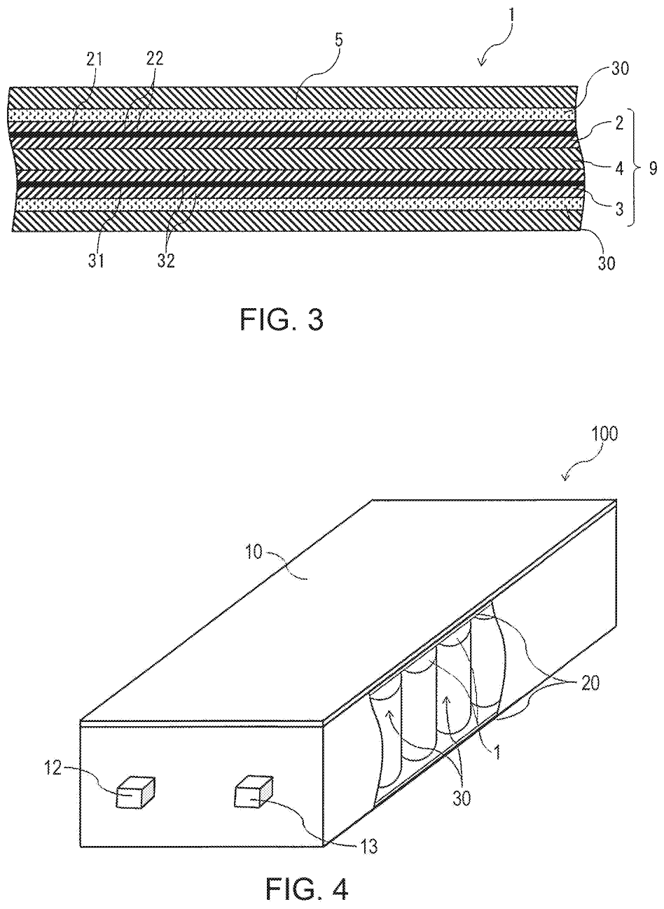

As shown in FIG. 3, the second heat storage sheet 30 may be disposed on the inside surface of a sealing body 5. In this case, the second heat storage sheet 30 coating the periphery of the cells 1 may be omitted or not omitted.

### First Embodiment

A first embodiment of the secondary battery of the present invention will be described.

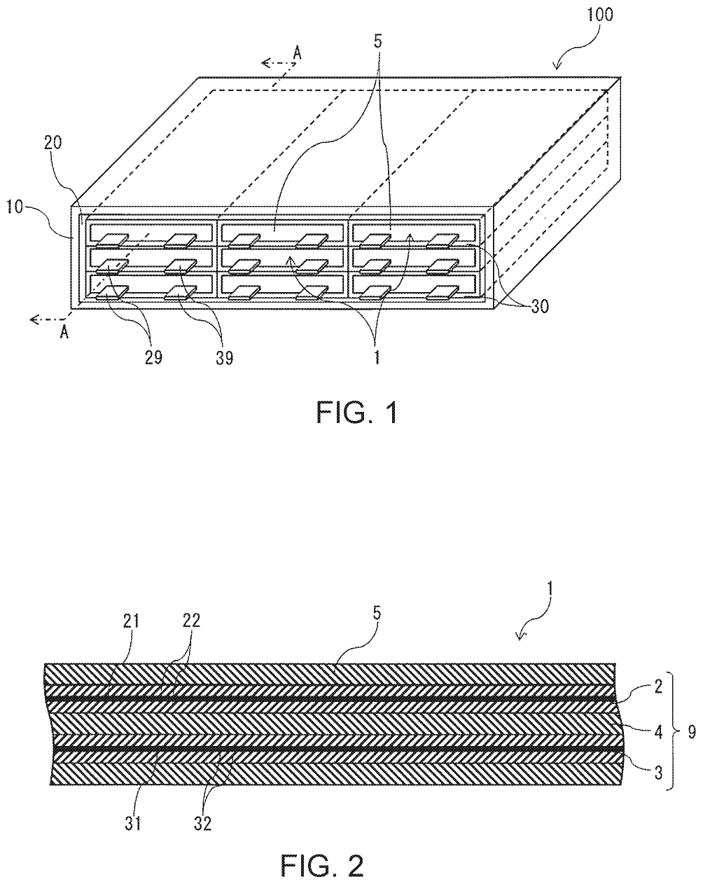

FIG. 1 is a perspective view showing a first embodiment of the secondary battery of the present invention; FIG. 2 is a partial cross-sectional view of a cell cut along the A-A line in FIG. 1; and FIG. 3 is a partial cross-sectional view showing another configuration of the cell.

The secondary battery 100 shown in FIG. 1 is, for example, a secondary battery that is loaded on a vehicle or the like and includes a plurality of cells 1 and a case 10 for accommodating the cells 1.

Each of the cells 1 includes, as shown in FIG. 2, a cell stack 9 including a positive electrode 2 having a positive electrode tab (positive electrode terminal) 29, a negative electrode 3 having a negative electrode tab (negative electrode terminal) 39, a separator 4 interposed between the positive electrode 2 and the negative electrode 3, and an electrolyte supported by the separator 4.

This cell stack 9 is, as shown in FIG. 1, sealed by the sealing body 5 in a state that the positive electrode tab 29 and the negative electrode tab 39 are exposed.

The second heat storage sheet 30 is disposed between the cells each including the cell stack 9. The second heat storage sheet 30 may be disposed so as to coat the periphery of the cell 1 (so as to wind the cell 1). When the second heat storage sheet 30 to be used has an incombustible layer 99 on only one surface of the coating layer containing a second heat storage material, the second heat storage sheet 30 may be disposed such that the surface on the incombustible layer 99 side is on the cell 1 side (for example, such that the incombustible layer 99 is in contact with the cell 1).

The positive electrode 2 of the present embodiment may include a positive electrode current collector (such as aluminum foil) 21 and a positive electrode active material layer 22 provided on each of both surfaces of the positive electrode current collector 21.

The positive electrode tab 29 is connected to the portion of the positive electrode current collector 21 exposed from the positive electrode active material layer 22. The positive electrode tab 29 is made of a metal piece (such as a copper piece, aluminum piece, or nickel piece). The positive electrode current collector 21 may be processed to form the positive electrode tab 29.

The positive electrode active material layer 22 contains, for example, a positive electrode active material and a conductive assistant.

The positive electrode active material is not particularly limited, but examples thereof include lithium metalate compounds such as lithium cobaltate, lithium nickelate, and lithium manganate, and a sodium layered compound. These lithium metalate compounds and sodium layered compounds may be used alone or in combination of two or more.

The conductive assistant is not particularly limited, but examples thereof include graphene and carbon black.

The positive electrode active material layer 22 may contain a binding agent (binding polymer) such as polyvinylidene fluoride as needed.

The negative electrode 3 of the present embodiment may include a negative electrode current collector (e.g., copper foil) 31 and a negative electrode active material layer 32 disposed on each of both surfaces of the negative electrode current collector 31.

The negative electrode tab 39 is connected to the portion of the negative electrode current collector 31 exposed from the negative electrode active material layer 32. The negative electrode tab 39 is made of a metal piece (such as a copper piece, aluminum piece, or nickel piece). The negative electrode current collector 31 may be processed to form the negative electrode tab 39.

The negative electrode active material layer 32 contains, for example, a negative electrode active material and a conductive assistant.

The negative electrode active material is not particularly limited, but examples thereof include carbon materials such as graphite (black lead), hard carbon, and soft carbon. These carbon materials may be used alone or in combination of two or more.

The conductive assistant is not particularly limited, but examples thereof include carbon nanotubes.

The negative electrode active material layer 32 contains a binding agent (binding polymer) such as polyvinylidene fluoride as needed.

The separator 4 is interposed between the positive electrode 2 and the negative electrode 3. The separator 4 has a function of preventing short circuit between the positive electrode 2 and the negative electrode 3 and a function of holding the electrolyte. The separator 4 holding the electrolyte can also be called an electrolyte layer.

The separator 4 can be constituted of, for example, a sheet material having a plurality of pores or a porous film such as non-woven fabric, as long as it has an insulating property and can hold an electrolyte.

Examples of the constituent material of the porous film include polyolefins such as polypropylene and polyethylene.

The electrolyte may be used as an electrolytic solution in which the electrolyte is dissolved in a non-aqueous solvent. The electrolyte (electrolytic solution) functions as a transfer medium for metal ions during charging and discharging the cell 1.

Examples of the non-aqueous solvent include propylene carbonate and ethylene carbonate. These non-aqueous solvents may be used alone or in combination of two or more.

Examples of the electrolyte include salts of lithium and fluoride, such as lithium tetrafluoroborate and lithium hexafluorophosphate, and salts of sodium and fluoride, such as sodium hexafluorophosphate.

As the electrolyte, an electrolyte polymer also can be used.

The sealing body 5 can be constituted of a stack (laminate film) of metal foil and a resin sheet, a metal can body, or the like.

The secondary battery 100 of the present embodiment may be configured by accommodating a plurality of the cells 1 in a case 10.

The case 10 can be formed from, for example, a metal material such as aluminum, iron, or an alloy thereof or a resin material such as polyphenylene sulfide.

The case 10 is configured of a box-shaped member having a bottom and a peripheral wall and is mounted with a lid member (not shown) so as to block the opening. The lid member is provided with a positive electrode terminal for external connection to be connected to a plurality of positive electrode tabs 29 at once and a negative electrode terminal for external connection to be connected to a plurality of negative electrode tabs 39 at once, in a state that the lid member is mounted on the case 10.

A first heat storage sheet 20 containing a first heat storage material may be disposed on the inside surface or the outside surface of the case 10. It is more preferable that the first heat storage sheet 20 is fixed to the inside surface of the case 10. Constituting the case 10 with a resin material contributes to reducing the weight of the secondary battery 100 and also can enhance the adhesion between the case 10 and the first heat storage sheet 20.

The heat storage material is a substance that absorbs heat when the phase changes from solid to liquid and releases heat when the phase changes from liquid to solid.

Accordingly, if a heat storage material having a relatively low temperature at which phase change occurs is selected, when the temperature of the cells 1 decreases as the ambient temperature decreases, a reduction in the temperature of the cells 1 can be prevented by releasing the heat stored in the heat storage material.

In contrast, if a heat storage material having a relatively high temperature at which phase change occurs (i.e., melting point) is selected, an increase in the temperature of the cells 1 can be prevented by absorbing the heat generated during charging of the secondary battery 100 (cells 1) with the heat storage material.

In one or more embodiments, a heat storage material with a relatively low melting point is used as the first heat storage material. In this case, since the first heat storage material is present to be scattered near the inside surface of the case 10, the first heat storage material can smoothly absorb and release heat according to the change of the peripheral temperature in a low temperature region.

Accordingly, it is possible to keep the cells 1 warm in a certain period of time from stop to next start by fixing the first heat storage sheet 20 to the inside surface of the case 10. As a result, it is possible to prevent the voltage of the secondary battery 100 (vehicle) from significantly decreasing.

The specific melting point of the first heat storage material may be −30° C. or more and 15° C. or less, −10° C. or more and 10° C. or less, or 0° C. or more and 8° C. or less. The heat keeping effect of the cells 1 after stopping can be further improved by using a first heat storage material having a melting point within the range above.

The first heat storage material is not particularly limited, but examples thereof include fatty acid ester and alkane (paraffin). These compounds may be used alone or in combination of two or more.

Examples of the fatty acid ester include methyl decanoate, ethyl decanoate, methyl laurate, ethyl laurate, ethyl myristate, methyl palmitoleate, and methyl oleate. In particular, the fatty acid ester may be methyl laurate, ethyl laurate, ethyl myristate, or methyl palmitoleate or methyl laurate.

Examples of the alkane include decane, undecane, dodecane, tridecane, tetradecane, and pentadecane. In particular, the alkane may be tridecane, tetradecane, or pentadecane or tetradecane.

The first heat storage material may be in a state of coated particles coated with an outer shell composed of an organic material such as a melamine resin, an acrylic resin, or a urethane resin.

In this case, the average particle diameter of the coated particles is not particularly limited, but may be 10 to 3000 μm. In the first heat storage sheet 20, voids are easily formed between coated particles by using coated particles having an average particle diameter within the range above, and good moldability is easily achieved.

The average particle diameter may be 30 μm or more, 50 μm or more, or 100 μm or more. The average particle diameter may be 2000 μm or less or 1000 μm or less because it is easy to firmly hold the coated particles on the first heat storage sheet 20, in addition to forming suitable voids and good moldability. The primary particles may have an average particle diameter in the range above.

The average particle diameter of the coated particles can be the median diameter (particle diameter corresponding to 50% of volume cumulative distribution: 50% particle diameter) obtained by measurement with a laser diffraction particle size analyzer (manufactured by HORIBA, Ltd., “LA-950V2”).

The first heat storage sheet 20 may hold the first heat storage material (coated particle) and contains a resin for bonding between first heat storage material molecules. A first heat storage sheet 20 having voids is easily produced by bonding between the first heat storage material molecules by the resin into a three-dimensional mesh shape.

When an aqueous dispersion of a resin is mixed with the first heat storage material to prepare a mixture solution, the resin to be used may have an absorption amount of the aqueous dispersion of 70 parts by mass or less with respect to 100 parts by mass of the first heat storage material. In this case, voids with a suitable size are easily secured in the first heat storage sheet 20, and the first heat storage sheet 20 with a high mechanical strength can be produced by firmly bonding between first heat storage material molecules with the resin. Good coatability of the mixture solution is secured also during the production thereof, and it becomes easy to produce the first heat storage sheet 20.

The absorption amount may be 60 parts by mass or less, 55 parts by mass or less, or 50 parts by mass or less. The lower limit of the absorption amount is generally about 10 parts by mass. The absorption amount of the aqueous dispersion with respect to the first heat storage material can be measured in accordance with JIS K5101-13-1. As the aqueous dispersion of a resin, an aqueous dispersion prepared by dispersing 55 parts by mass of the resin in 45 parts by mass of water may be used.

The state of the resin is not particularly limited as long as it can produce a first heat storage sheet 20 (matrix) having voids. However, an emulsion resin that can form voids by mechanical foaming is suitable because the overall structure of the first heat storage sheet 20 can be easily formed and formation of good voids and the content of the voids (porosity) are easily secured.

Accordingly, the first heat storage sheet 20 may be constituted of foam containing a first heat storage material. Consequently, the heat-retaining property of the first heat storage sheet 20 can be more enhanced.

Examples of the emulsion resin include an acrylic emulsion resin, a urethane emulsion resin, an ethylene-vinyl acetate emulsion resin, a vinyl chloride emulsion resin, and an epoxy emulsion resin. In particular, the acrylic emulsion resin is preferable because of its excellent heat-resisting property and heat-insulating property, and the urethane emulsion resin is preferable because of its excellent flexibility.

The average particle diameter of the emulsion resin may be 30 to 1500 nm or 50 to 1000 nm because it is easy to coat the first heat storage material and to bond between the first heat storage material molecules coated with the resin.

The average particle diameter of the emulsion resin can be the 50% median diameter measured by dynamic light scattering, for example, 50% median diameter based on volume measured with Microtrack UPA particle size distribution measuring apparatus manufactured by Nikkiso Co., Ltd.

The first heat storage sheet 20 may have a structure in which the first heat storage material is coated with a resin and the first heat storage material molecules are bonded to each other by the resin. The first heat storage sheet 20 in such a configuration can contain both the first heat storage material and voids at high densities, compared to a configuration in which the first heat storage material is held by a molded foam material and a configuration in which closed cells and the first heat storage material are dispersed in a matrix of the resin.

Since it is easy to control both the content rate of the voids (porosity) and the content rate of the first heat storage material, the heat storage property, heat-retaining property, and heat-insulating property of the first heat storage sheet 20 also can be suitably controlled. Furthermore, molding and processing into a sheet shape are easy due to a light weight, falling of the first heat storage material is also unlikely to occur, and addition of flexibility is also easy.

The first heat storage sheet 20 has a structure having voids between first heat storage material molecules by bonding of the reins-coated first heat storage material molecules by the resin. Accordingly, the specific gravity of the first heat storage sheet 20 may be 0.15 to 0.9 or 0.3 to 0.9. In this case, the first heat storage sheet 20 easily obtains a high heat-retaining property. In this case, the weight of the first heat storage sheet 20 is easily decreased, and a good processability is also obtained.

The content of the first heat storage material in the first heat storage sheet 20 may be 10 to 90 mass %, 20 to 80 mass %, or 30 to 70 mass % because suitable heat storage property and heat-retaining property are easily realized.

The content of the resin in the first heat storage sheet 20 may be 10 to 90 mass %, 20 to 80 mass %, or 30 to 70 mass % because the contents of the voids and first heat storage material are easily controlled to easily improve both the contents.

In addition, the quantity ratio of the first heat storage material and the resin, as the solid content mass ratio represented by (first heat storage material)/resin, may be 80/20 to 15/85 and or 70/30 to 30/70 because suitable heat-retaining property and heat-insulating property are easily obtained.

The first heat storage sheet 20 is easy to process, such as cutting, and is therefore excellent in a handling property.

The thickness of the first heat storage sheet 20 is not particularly limited, but may be 100 to 6000 μm, 300 to 4000 μm, or 500 to 3000 μm. In this case, the heat storage property and heat-retaining property of the first heat storage sheet 20 can be more improved.

In the first heat storage sheet 20, the mandrel diameter at which cracking occurs in a bending resistance test in accordance with JIS K5600-5-1 (1999) may be 25 mm or less, 20 mm or less, or 16 mm or less. The first heat storage sheet 20 satisfying the above requirements can secure suitable flexibility and excellent conformability to the surfaces of various members.

The bending resistance of the first heat storage sheet 20 measured in accordance with the Gurley method regulated in JIS L1913 (2010) may be 0.1 to 30 mN, 0.5 to 20 mN, or 1 to 10 mN. The first heat storage sheet 20 having such a bending resistance also can secure suitable flexibility and excellent conformability to the surfaces of various members.

The tensile strength of the first heat storage sheet 20 may be 0.1 MPa or more or 0.2 MPa or more. In this case, the first heat storage sheet 20 can be provided with toughness while having flexibility. The first heat storage sheet 20 is preferred because cracks are unlikely to occur even during processing or transportation, and suitable processability, ease in handling, suitability for transportation, and suitability for bending can be expressed.

The upper limit of the tensile strength of the first heat storage sheet 20 is not particularly limited, but may be 15 MPa or less, 10 MPa or less, or 5 MPa or less.

The elongation percentage at the time of tensile fracture of the first heat storage sheet 20 may be 10% or more, 30% or more, or 50% or more. In this case, embrittlement of the first heat storage sheet 20 can be suppressed. In the first heat storage sheet 20, cracking and chipping are unlikely to occur even if bending or distortion occurs during processing or transportation.

The upper limit of the elongation percentage at the time of tensile fracture of the first heat storage sheet 20 may be 1000% or less, 500% or less, or 300% or less. In this case, the first heat storage sheet 20 can achieve excellent flexibility while being tough. Accordingly, the first heat storage sheet 20 can easily obtain good processability, ease in handling, suitability for transportation, and conformability to the surfaces of various members.

The tensile strength and the elongation percentage at the time of tensile fracture of the first heat storage sheet 20 can be measured, respectively, in accordance with the methods regulated in JIS K6251.

Specifically, the first heat storage sheet 20 is cut into the shape of dumbbell No. 2, and a test piece with two marked lines with an initial distance between the marked lines of 20 mm is produced. This test piece is attached to a tensile tester and is pulled at a rate of 200 mm/min until rupture. On this occasion, the maximum force (N) until the rupture and the distance (mm) between the marked lines at the time of rupture are measured, and the tensile strength and the elongation percentage at the time of tensile rupture can be calculated by the equations below.

The tensile strength TS (MPa) is calculated by the following equation.

TS=Fm/Wt

where Fm is the maximum force (N), W is the width (mm) of the parallel portion, and t is the thickness (mm) of the parallel portion.

The elongation percentage Eb (%) at the time of tensile rupture is calculated by the following equation.

Eb=(Lb−L0)L0×100

where Lb is the distance (mm) between marked lines at the time of rupture, and L0 is the initial distance (mm) between the marked lines.

The first heat storage sheet 20 may contain various additives as needed. Examples of the additive include a flame retardant, an adsorbent of hazardous substances such as formaldehyde, a color pigment, and a deodorant.

The first heat storage sheet 20 such as above mentioned can be produced by mechanically foaming a resin composition containing a resin, a first heat storage material, and an aqueous medium and then performing coating, casting, and drying. In the production of the first heat storage sheet 20, the resin composition may be dried and then cured by heat, ultraviolet rays, or the like as needed.

As the aqueous medium that can be used in preparation of the resin composition, water can be used.

The aqueous medium may be a mixture of water and a water-soluble solvent. Examples of the water-soluble solvent include alcohols, such as methyl alcohol, ethyl alcohol, isopropyl alcohol, ethyl carbitol, ethyl cellosolve, and butyl cellosolve, and polar solvents, such as N-methylpyrrolidone. These water-soluble solvents may be used alone or in combination of two or more.

The resin composition may be mixed with a surfactant, a thickener, a flame retardant, a crosslinking agent, and other additives as needed.

For example, in order to micronize or stabilize foamed foam, the resin composition can be mixed with any surfactant. As the surfactant, any of an anionic surfactant, a cationic surfactant, a nonionic surfactant, and an ampholytic surfactant may be used.

In particular, from the viewpoint of enhancing the stability of foamed foam, the surfactant may be an anionic surfactant or fatty acid ammonium surfactant such as ammonium stearate. The surfactants may be used alone or in combination of two or more.

The resin composition may be mixed with a thickener in a necessary amount for improving the stability of foamed foam and film formability. Examples of the thickener include an acrylic acid thickener, a urethane thickener, and a polyvinyl alcohol thickener. In particular, as the thickener, an acrylic acid thickener or a urethane thickener may be used.

The resin composition may be mixed with a flame retardant in a necessary amount for improving the incombustibility of the first heat storage sheet 20. The flame retardant is not particularly limited, but organic flame retardants and inorganic flame retardants can be appropriately used.

The organic flame retardant may be, for example, a phosphorous compound, a halogen compound, and a guanidine compound. Specific examples of the organic flame retardant include monoammonium phosphate, diammonium phosphate, phosphoric triester, phosphite ester, a phosphonium salt, phosphoric triamide, chlorinated paraffin, ammonium bromide, decabromobisphenol, tetrabromobisphenol A, tetrabromoethane, decabromodiphenyl oxide, hexabromophenyl oxide, pentabromo oxide, hexabromobenzene, guanidine hydrochloride, guanidine carbonate, and guanylurea phosphate.

The inorganic flame retardant may be, for example, a compound of antimony or aluminum, a boron compound, or an ammonium compound. Examples of the inorganic flame retardant include antimony pentoxide, antimony trioxide, sodium tetraborate decahydrate (borax), ammonium sulfate, and ammonium sulfamate.

As the flame retardant, the above compounds may be used alone or in combination of two or more.

The resin composition may be mixed with a curing agent in a necessary amount for improving the mechanical strength of the first heat storage sheet 20. The curing agent may be appropriately selected according to the type of the resin to be used, and examples thereof include an epoxy curing agent, a melamine curing agent, an isocyanate curing agent, a carbodiimide curing agent, and an oxazoline curing agent.

The content of the resin in the resin composition, for example, when an acrylic emulsion resin is used may be 30 to 200 parts by mass or 50 to 150 parts by mass based on 100 parts by mass of the aqueous medium. In this case, the viscosity of the resin composition is easily adjusted in a suitable range, and stable foaming becomes easy.

The content of the first heat storage material in the resin composition may be adjusted such that the quantity ratio of the (first heat storage material)/resin in the first heat storage sheet 20 is within the above range.

When the resin composition is mixed with a surfactant, the content thereof may be 30 parts by mass or less based on 100 parts by mass (solid content) of the resin, m 0.5 to 20 parts by mass, or 3 to 15 parts by mass, because suitable foamability is easily obtained.

When the resin composition is mixed with a thickener, the content thereof may be 0.1 to 10 parts by mass based on 100 parts by mass (solid content) of the resin or 0.5 to 8 parts by mass.

The first heat storage sheet 20 obtained by the above method may have an incombustible layer. The spread of fire of the cells constituting a secondary battery can be effectively suppressed by using a first heat storage sheet having the incombustible layer.

The first heat storage sheet 20 can be fixed to the inside surface of the case 10 with, for example, an adhesive, welding (ultrasonic welding, high frequency welding, or heat welding), or a gluing agent.

### Second Embodiment

FIG. 4 is a perspective view showing a partial cutaway of a second embodiment of the secondary battery of the present invention.

The secondary battery 100 of the second embodiment will now be described, but the explanation will focus on the differences between secondary batteries 100 of the first and second embodiments, and the explanations on similar items will be omitted.

In the secondary battery 100 shown in FIG. 4, a plurality of cylindrical cells 1 are arranged in a rectangular case 10. A first heat storage sheet 20 is then fixed to the inside surface of the case 10.

The plurality of cells 1 are accommodated (arranged) in the case 10 in a matrix form such that the longitudinal direction (axial direction) is the thickness direction (height direction) of the case 10. A positive electrode terminal 12 for external connection to be connected to a plurality of positive electrode tabs 29 at once and a negative electrode terminal 13 for external connection to be connected to a plurality of negative electrode tabs 39 at once are provided on the side surfaces of the case 10.

Furthermore, a separator 4 may be disposed inside the cells 1 so as to wind around the cells 1. That is, as each of the cells 1, a usual cylindrical cell also can be used.

In this case, the second heat storage sheet 30 may coat the circumference of each of the cells 1, or the second heat storage sheet 30 may coat a plurality of the cells 1 aligned in a row at once. When a second heat storage sheet 30 having an incombustible layer 99 on only one surface is used, the second heat storage sheet 30 may be disposed such that the surface on the incombustible layer 99 side is on the cell 1 side (for example, such that the incombustible layer 99 is in contact with the cells 1).

The secondary batteries of one or more embodiments of the present invention have been described above, but the present invention is not limited to the configurations of the above-described embodiments.

For example, in a secondary battery of one or more embodiments of the present invention, any other desired configuration may be added to the configuration in the above-described embodiments, or the configuration may be replaced with any configuration exhibiting a similar function.

The first heat storage sheet 20 and the second heat storage sheet 30 may be each a stack composed of a plurality of layers.

The first heat storage sheet 20 may be fixed to the inside surface of the case 10, and the second heat storage sheet 30 may be stacked on the inside thereof.

In the secondary battery of one or more embodiments of the present invention, the types of the positive electrode active material, the negative electrode active material, and the electrolyte are appropriately selected according to the ion species that are transferred during charge and discharge.

### EXAMPLES

One or more embodiments of the present invention will now be described in more detail by Examples, but is not limited thereto.

### 2. Production of Second Heat Storage Sheet

A plastisol coating solution was prepared by mixing 100 parts by mass of a polyvinyl chloride resin particle with a polymerization degree of 900 (manufactured by SHINDAI-ICHI VINYL CORPORATION, ZEST PQ92), 70 parts by mass of a polyester plasticizer (manufactured by DIC Corporation, Polycizer W-230H), 2 parts by mass of a dispersant (manufactured by DIC Corporation, Epocizer E-100EL) and 2 parts by mass of a dispersant (manufactured by BYK-Chemie GmbH, Disperplast-1142) as other additives, and 100 parts by mass of a coated particle (average particle diameter: 150 μm, melting point: 38° C.) prepared by microencapsulation of a second heat storage material containing methyl stearate using an outer shell composed of a urethane resin.

This plastisol coating solution was applied on incombustible paper with an applicator coater and was then heated at a dryer temperature of 150° C. for 8 minutes for gelation to produce a second heat storage sheet with a thickness of 1 mm.

The content of the coated particle included in the second heat storage sheet was 35.5 mass %.

### 3. Simulation Experiment of Temperature Rise Suppression

### 3-1. Preparation of Test Specimen

### Example B

Six aluminum (A1050) plates with a thickness of 1 mm, a width of 200 mm, and a length of 300 mm and three silicon rubber heaters with a width of 50 mm, a length of 100 mm, and a capacity of 30 W (manufactured by HAKKO Co., Ltd. “SBH2123”) were provided.

Subsequently, three simulation cells were produced by interposing one of the silicon rubber heater between two of the aluminum plates.

Subsequently, a second heat storage sheet was disposed between each of the simulation cells.

In order to measure the temperature between the second simulation cell from the top and each of the second heat storage sheets, two temperature sensors were installed.

### Comparative Example B1

A test specimen was prepared as in Example B except that vinyl chloride sheets (not containing the second heat storage material) with a thickness of 1 mm, a width of 150 mm, and a length of 150 mm were used instead of the second heat storage sheets.

### Comparative Example B2

A test specimen was prepared as in Example B except that the second heat storage sheets were omitted, wherein a gap of 1 mm was held between each of the simulation cells.

### 3. Experiment Method

The test specimens were each placed in an environment of 25° C., and in such a state, a heat generation of 30 W by the silicon rubber heater was continued for 10 minutes, and then the silicon rubber heater was off, followed by leaving to stand for 30 minutes.

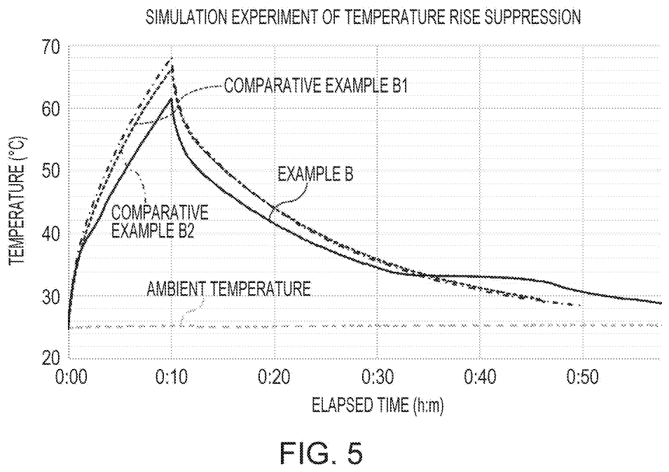

On this occasion, the temperature change at each of the measurement points was recorded. The results thereof are shown in FIG. 5.

As shown in FIG. 5, an increase in the temperature of the cells can be suppressed by fixing the second heat storage sheets.

### 4. Combustion Test

### 4-1. Preparation of Test Specimen

A combustion test apparatus defined in JIS D1201 was used.

### Example C1

A plastisol coating solution was prepared by mixing 100 parts by mass of a polyvinyl chloride resin particle with a polymerization degree of 900 (manufactured by SHINDAI-ICHI VINYL Corporation, ZEST PQ92), 70 parts by mass of a polyester plasticizer (manufactured by DIC Corporation, Polycizer W-230H), 2 parts by mass of a dispersant (manufactured by DIC Corporation, Epocizer E-100EL) and 2 parts by mass of a dispersant (manufactured by BYK-Chemie GmbH, Disperplast-1142) as other additives, and 100 parts by mass of a coated particle (average particle diameter: 150 μm, melting point: 38° C.) prepared by microencapsulation of a second heat storage material containing methyl stearate using an outer shell composed of a urethane resin.

This plastisol coating solution was applied on incombustible paper with an applicator coater and was then heated at a dryer temperature of 150° C. for 8 minutes for gelation to produce a second heat storage sheet with a thickness of 3 mm, a width of 65 mm, and a length of 200 mm. The content of the coated particle included in the second heat storage sheet was 35.5 mass %. The combustion of the second heat storage sheet was performed by the method shown in “4-2. Experiment method” below. On the occasion, the flame was adjusted so as to be in contact with the surface made of incombustible paper constituting the second heat storage sheet.

### Example C2

The combustion was evaluated by the method shown in “4-2. Experiment method” below using the same second heat storage sheet as that used in Example C1. On the occasion, the flame was adjusted so as to be in contact with the side of the layer containing the heat storage material constituting the second heat storage sheet (the opposite side to the surface made of incombustible paper).

### Comparative Example C

A second heat storage sheet was produced by the same method as in Example C1 except that the incombustible paper was not used. The combustion was evaluated by the same method as in Example C1 except that the second heat storage sheet produced in Comparative Example C was used as the test piece instead of the second heat storage sheet used in Example C1.

### 4-2. Experiment Method

A test piece was installed to a test piece fixture composed of two U shaped metal plates, a combustion test was performed by the following method, the combustion distance (mm) and the combustion time (s) were measured, and other observations (such as automatic extinction) were recorded.
A gas with a calorific value of about 38 MJ/m³ is used as the gas of the gas burner.
The flame of the gas is adjusted to a height of 38 mm. In order to stabilize the flame, the flame is burned for 1 minute or more.
The test piece fixture is pushed into the inside of the combustion test apparatus, and the end part of the test piece is subjected to the flame. After subjecting to the flame for 15 seconds, the gas is stopped.
In the measurement of the combustion time, the position of 50 mm from the end part of the test piece is defined as the measurement start point, and the measurement starts when the root of the ignited flame has reached the end part of the test piece. How the flame spreads on the surface where the combustion speed is greater than that on other surfaces is observed.
The measurement of combustion time is ended when the flame has reached the measurement end point or when the flame has gone out before reaching the measurement end point. The measurement end point is a point 150 mm away from the measurement start point. When the flame does not reach the measurement end point, the distance between the position at which the flame has gone out and the measurement start point is measured and is defined as the combustion distance shown in the table. The portion where the combustion distance is measured is the deteriorated portion whose surface or inside has been damaged by combustion.

TABLE 1

| | Combustion | Combustion | Other |
|---|---|---|---|
| | distance (mm) | time (s) | observation |
| Example C1 | 0 | 0 | No ignition |
| Example C2 | 40 | 20 | Automatic |
| | | | extinction |
| Comparative | 150 | 397 | Entire |
| Example C | | | combustion |

### REFERENCE SIGNS LIST

100 secondary battery
1 cell
2 positive electrode
21 positive electrode current collector
22 positive electrode active material layer
29 positive electrode tab
31 negative electrode current collector
32 negative electrode active material layer
39 negative electrode tab
4 separator
5 sealing body
9 cell stack
10 case
11 barrel
12 positive electrode terminal for external connection
13 negative electrode terminal for external connection
20 first heat storage sheet
30 second heat storage sheet

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A secondary battery, comprising:
two or more cells each including a cell stack; and
a second heat storage sheet including an incombustible layer,
wherein the cell stack comprises:
a positive electrode having a positive electrode terminal;
a negative electrode having a negative electrode terminal;
a separator interposed between the positive electrode and the negative electrode; and
an electrolyte held by the separator, and
the second heat storage sheet is disposed between the two or more cells.

2. The secondary battery according to claim 1, wherein the second heat storage sheet is disposed so as to isolate the two or more cells adjacent from each other.

3. The secondary battery according to claim 2, wherein the two or more cells are coated with the second heat storage sheet in a state that the positive electrode terminal and the negative electrode terminal are exposed.

4. The secondary battery according to claim 1, wherein the incombustible layer is aluminum, incombustible paper, or iron.

5. The secondary battery according to claim 1, wherein the second heat storage sheet has a thickness of 100 to 6000 μm, and the incombustible layer has a thickness of 3 to 1000 μm.

6. The secondary battery according to claim 1, wherein the two or more cells and the second heat storage sheet are accommodated in a case, wherein a first heat storage sheet that is different from the second heat storage sheet is disposed on an inside surface or an outside surface of the case.

7. The secondary battery according to claim 6, wherein a second heat storage material included in the second heat storage sheet has a melting point of greater than 15° C. and 70° C. or less, and a first heat storage material included in the first heat storage sheet has a melting point of −30° C. or more and 15° C. or less.

8. The secondary battery according to claim 7, wherein the first heat storage sheet is constituted of foam containing the first heat storage material.
